(19) United States
(12) Patent Application Publication
(10) Pub. No.: US 2022/0374523 A1
(43) Pub. Date: Nov. 24, 2022

(54) NON-TRANSITORY COMPUTER READABLE MEDIUM AND INFORMATION PROCESSING APPARATUS

(71) Applicant: FUJIFILM Business Innovation Corp., Tokyo (JP)

(72) Inventor: Kentaro TAKANO, Kanagawa (JP)

(73) Assignee: FUJIFILM Business Innovation Corp., Tokyo (JP)

(21) Appl. No.: 17/462,755

(22) Filed: Aug. 31, 2021

(30) Foreign Application Priority Data
May 18, 2021 (JP) 2021-084102

(51) Int. Cl. G06F 21/57

(52) U.S. Cl. CPC G06F 21/577; G06F 2221/034

(57) ABSTRACT

A non-transitory computer readable medium stores a program causing a computer to execute a process, the process executing an application program corresponding to a sequence of a first phase updating a definition file of a virus, a second phase diagnosing with the definition file used and controlling the virus, a third phase assessing vulnerability, and a fourth phase applying a correction program.

### CROSS-REFERENCE TO RELATED APPLICATIONS

This application is based on and claims priority under 35 USC 119 from Japanese Patent Application No. 2021-084102 filed May 18, 2021.

### BACKGROUND

### (i) Technical Field

The present disclosure relates to a non-transitory computer readable medium and an information processing apparatus.

### (ii) Related Art

Services are available to connect via remote desktop to a terminal suspected of being infected with malware, diagnose the terminal, control the malware, and restore the terminal. Such service is performed by connecting the terminal suspected being infected with malware to a network. If the terminal is infected with the malware (also referred to a “virus”), information leak may occur or another terminal may also be infected. In one of available techniques, security software called endpoint detection and response (EDR) monitors the behavior of a terminal. If an irregularity is detected, communication other than communication used to respond to the irregularity is blocked. This blocking is hereinafter referred to as isolation. Reference is made to Japanese Unexamined Patent Application Publication No. 2010-193268.

Jobs performed during isolation may be performed on applications (apps) other than a predetermined app. In such a case, there is a possibility that communication performed by app vulnerable to a virus is permitted. If a patch is applied to the operating system of Windows (registered trademark), communication by svchost.exe is to be permitted and the virus may communicate via svchost.exe. It looks like that a subject of the communication is svchost.exe. If the communication of svchost.exe is permitted, the virus may virtually abuse the communication.

### SUMMARY

Aspects of non-limiting embodiments of the present disclosure relate to permitting communication performed to respond to isolation while reducing the risk that permitted communication is abused by a virus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a non-transitory computer readable medium storing a program causing a computer to execute a process, the process executing an application program corresponding to a sequence of a first phase updating a definition file of a virus, a second phase diagnosing with the definition file used and controlling the virus, a third phase assessing vulnerability, and a fourth phase applying a correction program.

### BRIEF DESCRIPTION OF THE DRAWINGS

Exemplary embodiments of the present disclosure will be described in detail based on the following figures, wherein:

FIG. 1 illustrates a concept of a cloud system used in a service of a first exemplary embodiment;

FIG. 2 illustrates an example of a hardware configuration of a computer used in support desk;

FIG. 3 illustrates an example of a hardware configuration of a computer used in a client system;

FIG. 4 illustrates an example of a white list stored on a hard disk;

FIG. 5 illustrates an example of a screen that an administrator of the support desk utilizes for security arrangement;

FIG. 6 is a flowchart illustrating the process of a program executed on a computer operated by an administrator who is in charge of providing a security arrangement service;

FIGS. 7A through 7D illustrate the transition of a screen used in a security arrangement, wherein FIG. 7A illustrates an example of a screen immediately after the start of the security arrangement, FIG. 7B illustrates an example of a screen when the update of a definition file is complete, FIG. 7C illustrates a screen when a virus is controlled, and FIG. 7D illustrates a screen when vulnerability assessment ends;

FIG. 8 illustrates an example of communication performed between a computer on a support desk side and a computer on a client system;

FIG. 9 is a flowchart illustrating the process of another program executed on the computer operated by the administrator who provides the security arrangement service;

FIG. 10 illustrates a security arrangement screen used in a second exemplary embodiment;

FIGS. 11A and 11B illustrate a display example of an error message displayed when a wrong phase button is operated, wherein FIG. 11A illustrates an operation example of a button operated by the administrator, and FIG. 11B illustrates a display example of the error message;

FIGS. 12A and 12B illustrate a display example of an error message displayed when a wrong phase button is operated, wherein FIG. 12A illustrates an operation example of a button operated by the administrator, and FIG. 11B illustrates a display example of the error message;

FIG. 13 illustrates a security arrangement screen used in a third exemplary embodiment;

FIG. 14 illustrates an example of communication performed between the computer on the support desk side and the computer on the client system side;

FIG. 15 is a flowchart illustrating the process of another program executed by a computer operated by the administrator who provides the security arrangement service;

FIG. 16 illustrates an example of a security arrangement screen used in a fifth exemplary embodiment;

FIG. 17 is a flowchart illustrating the process of a program executed by a computer operated by the administrator who provides the security arrangement service;

FIG. 18 illustrates an example of communication performed between the computer on the support desk side and the computer on the client system side;

FIG. 19 illustrates an example of a security arrangement screen used in a sixth exemplary embodiment;

FIG. 20 is a flowchart illustrating the process of another program executed by the computer operated by the administrator who provides the security arrangement service;

FIGS. 21A and 21B illustrate a display example of an error message displayed when a wrong phase button is operated, wherein FIG. 21A illustrates an operation example of a button operated by the administrator, and FIG. 21B illustrates a display example of the error message;

FIG. 22 illustrates a white list stored on a hard disk device;

FIG. 23 illustrates an example of a process performed in a phase in which multiple white lists are available; and

FIG. 24 illustrates a configuration example of a local area network (LAN) system according to an eighth exemplary embodiment.

### DETAILED DESCRIPTION

Exemplary embodiments of the disclosure are described with reference to the drawings.

### First Exemplary Embodiment

### Example of System Configuration

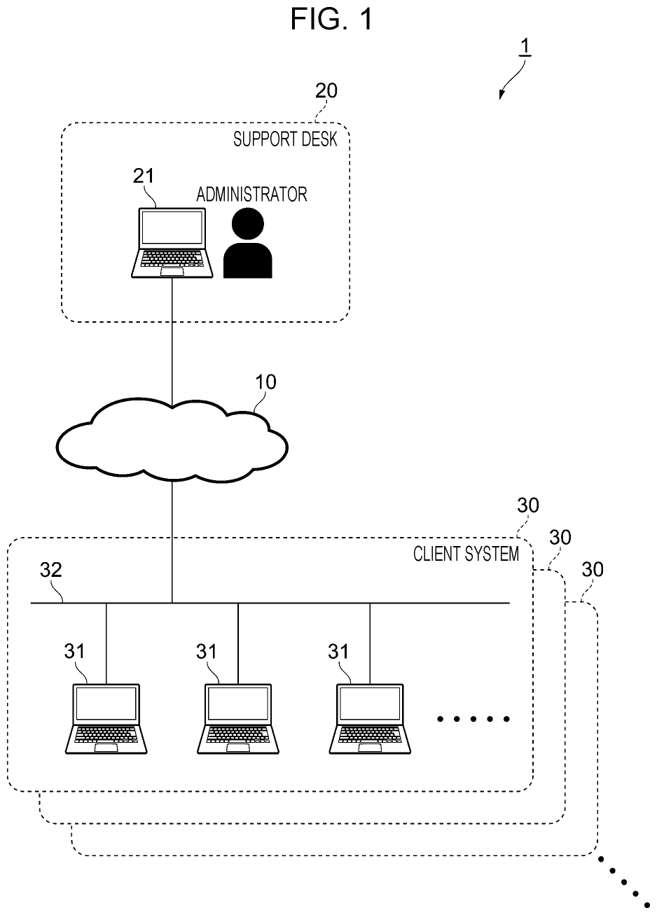

FIG. 1 illustrates a concept of a cloud system 1 used in a service of a first exemplary embodiment.

The service may be used to diagnose a computer that is suspected of being infectious a computer virus (hereinafter referred to as virus), control the virus from, and restore the computer. The computer serving as a service target is not necessarily infectious of a virus.

In the discussion that follows, the service of the exemplary embodiments is also referred to as a “security arrangement service.”

The cloud system 1 in FIG. 1 includes a support desk 20 operated by a company providing the security arrangement service and a client system 30 operated by a company using the security arrangement service.

The support desk 20 and client system 30 are interconnected to each other via the Internet 10.

Referring to FIG. 1, the Internet 10 is connected to multiple client systems 30.

The client systems 30 may be operated by the same company or different companies.

A mobile communication system, such as 4G or 5G, may be used instead of the Internet 10.

The support desk 20 includes a computer 21 operated by an administrator.

Although FIG. 1 illustrates a single computer 21, multiple computers 21 may be employed.

The administrator is an example of a worker in charge of security arrangements.

When the security arrangement service is provided, a computer 31 serving as a target of the security arrangement service and the computer 21 operated by the administrator are connected to each other via a remote desktop.

The client system 30 includes a local-area network (LAN) 32 and multiple computers 31 serving as targets of the security arrangement service.

Any number of the computers 31 serving as the targets of the security arrangement service may be employed. For example, one computer 31 may be employed.

Hardware Configuration of Computer on Support Desk Side

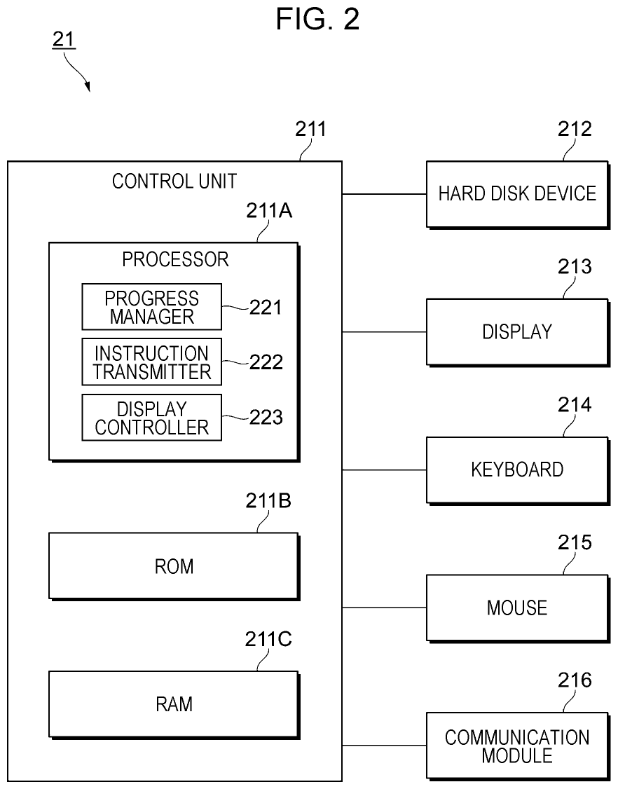

FIG. 2 illustrates a hardware configuration of the computer 21 used on the support desk 20.

The computer 21 in FIG. 2 includes a control unit 211, hard disk device 212, display 213, keyboard 214, mouse 215, and communication module 216. The computer 21 is an example of an information processing apparatus.

The control unit 211 includes the processor 211A, read-only memory (ROM) 211B, and random-access memory (RAM) 211C.

The processor 211A includes, for example, a central processing unit (CPU). The processor 211A implements a variety of functions by executing programs.

The ROM 211B stores, for example, basic input/output system (BIOS). The RAM 211C serves as a work area of the programs.

The hard disk device 212 is an auxiliary storage device and stores an operating system and application programs. The operating system and application programs are simply referred to as “programs.”

According to the first exemplary embodiment, the hard disk device 212 stores an application program that assists in providing services of an administrator.

According to the first exemplary embodiment, the hard disk device 212 is used. Alternatively, a semiconductor memory may be used in place of the hard disk device 212.

The display 213 displays a screen operated by the administrator. For example, the display 213 may be a liquid-crystal display or an electroluminescent (EL) display. For example, the display 213 may be a touch panel. The touch panel is a liquid-crystal display or EL display and a light-transmissive electrostatic capacitance touch sensor on the surface of the liquid-crystal display or EL display.

The administrator utilizes the keyboard 214 and mouse 215 to enter operations.

The communication module 216 is used to communicate with the outside and may be a wired or wireless device.

The processor 211A of the first exemplary embodiment includes a progress manager 221, instruction transmitter 222, and display controller 223. The progress manager 221 manages the progress of the security arrangement by executing an application program assisting in providing the security arrangement service. The instruction transmitter 222 transmits an instruction for the security arrangement to the computer 31 connected via remote desktop. The display controller 223 controls the displaying of the display 213.

The progress manager 221 provides a function of guiding the administrator such that the security arrangement for the computer 31 connected via the remote desktop is carried out in a correct order.

Specifically, the progress manager 221 provides a function of causing the security arrangement to proceed in an order of sequence that reduces the risk that communication of the computer 31 is abused by a virus during the security arrangement.

### Hardware Configuration of Computer on Client System Side

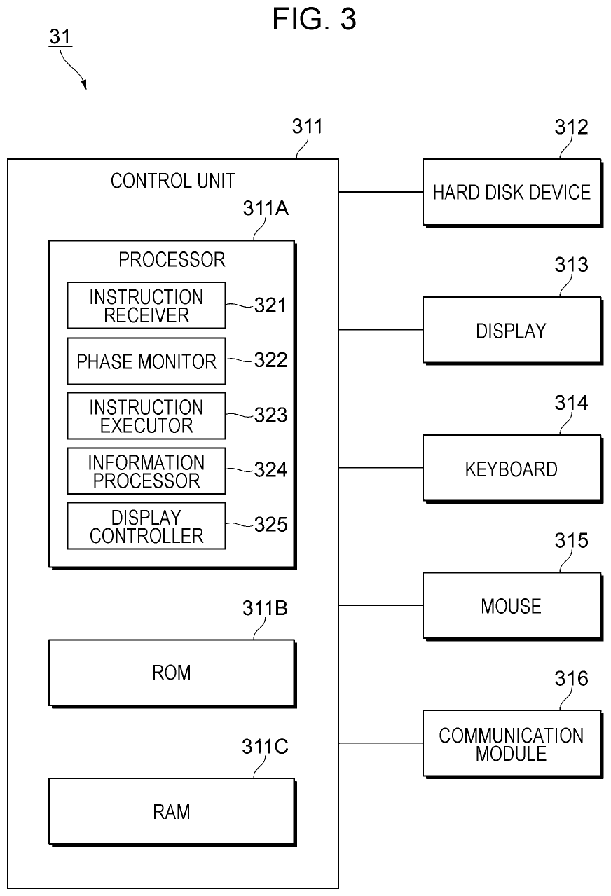

FIG. 3 illustrates an example of a hardware configuration of the computer 31 used in the client system 30.

The computer 31 in FIG. 3 includes a control unit 311, hard disk device 312, display 313, keyboard 314, mouse 315, and communication module 316.

The control unit 311 includes a processor 311A, ROM 311B, and RAM 311C.

The processor 311A may include a CPU. The processor 311A implements a variety of functions by executing programs.

The ROM 311B stores, for example, BIOS. The RAM 311C is used as a work area of a program.

The hard disk device 312 is an auxiliary storage device and stores an operating system and application programs.

According to the first exemplary embodiment, the hard disk device 312 stores a white list used in the security arrangement and a program supporting communication that is permitted to be used via the white list.

A semiconductor memory may be used in place of the hard disk device 312.

The display 313 displays a screen that the administrator utilizes for operation. For example, the display 313 is a liquid-crystal display or EL display. The display 313 may be a touch panel.

The keyboard 314 and mouse 315 may be used by the administrator for operation.

The communication module 316 is used in communication with the outside. The communication module 316 may be a wired communication device or a wireless communication device.

The processor 311A of the first exemplary embodiment includes, as functions related to the security arrangement, an instruction receiver 321, phase monitor 322, and instruction executor 323. The instruction receiver 321 receives an instruction from the computer 21 on the side of the support desk 20 (FIG. 1) connected via the remote desktop. The phase monitor 322 monitors a phase currently in progress. The instruction executor 323 executes the received instruction.

According to the first exemplary embodiment, the phase monitor 322 monitors the progress of each of a phase of updating a definition file used in detecting a virus via communication with the outside (definition file update phase), a phase of controlling the virus using the definition file (virus control phase), a phase of assessing vulnerability via the communication with the outside (vulnerability assessment phase), and a phase of applying a patch via the communication with the outside (patch application phase).

The definition file update phase is an example of a first phase, the virus control phase is an example of a second phase, the vulnerability assessment phase is an example of a third phase, and the patch application phase is an example of a fourth phase.

The processor 311A includes, as general-purpose functions, an information processor 324 and display controller 325. The information processor 324 performs information processing that a user operating the computer 31 instructs to be performed. The display controller 325 controls the display 313.

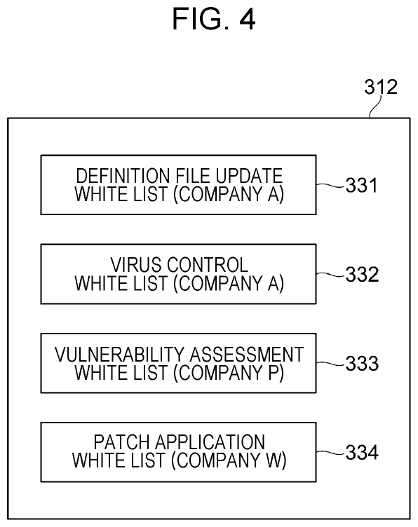

FIG. 4 illustrates an example of the white lists stored on the hard disk device 312. According to the first exemplary embodiment, the four phases have respective dedicated white lists.

A definition file update white list 331 is stored for the definition file update phase.

A virus control white list 332 is stored for the virus control phase.

According to the first exemplary embodiment, the definition file update white list 331 and virus control white list 332 permit a product of the same company to communicate. Referring to FIG. 4, the same company is a company A.

For example, the companies providing anti-virus software used in the virus control phase may include McAfee (registered trademark) Corp. and Microsoft (registered trademark) Corporation.

A vulnerability assessment white list 333 is stored for the vulnerability assessment phase.

For example, the company providing software used in the vulnerability assessment phase is Acronis (registered trademark). Referring to FIG. 4, the company providing software used in the vulnerability assessment phase is company P.

A patch application white list 334 is stored for the patch application phase. The word “patch” refers to a patch file and signifies a program correcting a defect in security. The patch is also referred to as a “correction program.”

For example, the company providing software used in the patch application phase is Microsoft Corp. Referring to FIG. 4, the company providing software used in the patch application phase is company W.

A combination of white lists related to the security arrangement is determined depending on the computer 31 that is a target of the security arrangement service.

The combination of white lists may be common to multiple client systems 30 (FIG. 1) or may be different depending on the client system 30.

The white list describes programs that are permitted to communicate in each phase. In other words, a program not described in the white list is not permitted to communicate with the outside.

In the white list, a location where a program file with an extension “.exe” is stored is described in a full path format.

The description of the white list is not limited to the full path format. A service name identifying the program may be used.

### Example of Administrator Screen

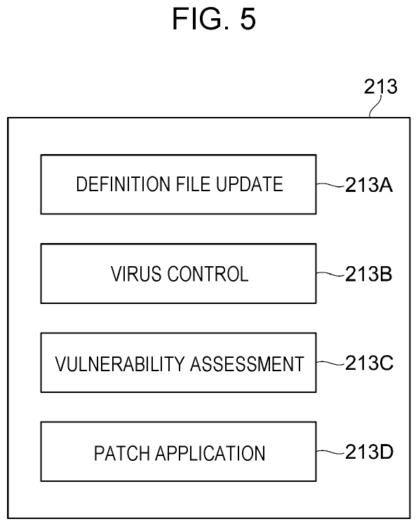

FIG. 5 illustrates an example of a screen that an administrator of the support desk 20 (FIG. 1) utilizes for security arrangement. The screen in FIG. 5 is displayed on the display 213 of the computer 21 (FIG. 1) operated by the administrator.

Four buttons corresponding to the four phases for the security arrangement are displayed on the screen in FIG. 5. The four buttons are example of operators.

Referring to FIG. 5, the display 213 includes a definition file update button 213A, virus control button 213B, vulnerability assessment button 213C, and patch application button 213D.

These buttons are selected in response to the clicking of a mouse or a tapping on the screen.

The computer 21 having received the selection of a button instructs the computer 31 (FIG. 1) serving as a providing destination of the security arrangement service to perform a phase corresponding to the selected button.

The communications used for the phases are not the same. Specifically, the four phases employs respective different communications.

According to the first exemplary embodiment, communication permitted in a phase is limited to the communication involved in the phase so as to reduce the possibility that the communication is abused by a virus.

Specifically, a white list is prepared for each phase and only the communication supported by a program included in the white list is permitted.

When the definition file update phase and virus control phase are complete, the safety of the computer 31 is higher than before the definition file update phase and the virus control phase are performed. This is because viruses detectable via the latest definition file are all removed from the computer 31.

According to the first exemplary embodiment, the phases are managed and executed in an order of sequence of higher to lower risk that the communication is abused by the viruses. Specifically, the buttons operable by the administrator are restricted in a predetermined order of sequence to reduce the risk that the communication of the computer 31 in isolation is abused.

### Providing Security Arrangement Service

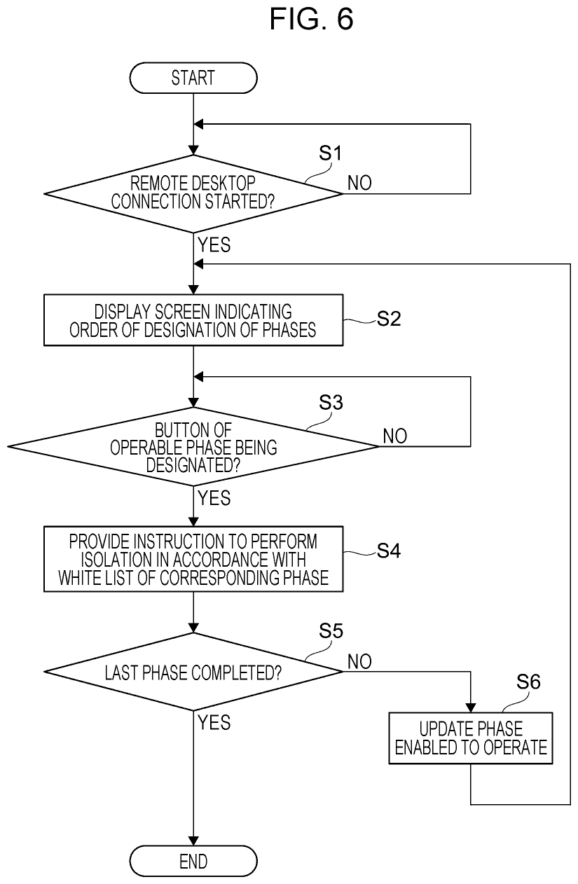

FIG. 6 is a flowchart illustrating the process of a program executed by the computer 21 (FIG. 1) operated by the administrator who is in charge of providing the security arrangement service. In FIG. 6, the letter S in the symbol numbers refers to step.

The process in FIG. 6 is performed by the processor 211A (FIG. 2) in the computer 21.

The process in FIG. 6 is performed with the computer 31 (FIG. 1) serving as the providing destination of the security arrangement service connected to the computer 21 via the remote desktop.

The processor 211A determines whether a remote desktop connection with the computer 31 serving as the providing destination of the security arrangement has started (step S1).

While the no path is followed in step S1, the processor 211A repeats the determination operation in step S1.

If the yes path is followed in step S1, the processor 211A displays on the display 213 (FIG. 2) a screen indicating the order of designation of the phase (step S2).

According to the first exemplary embodiment, only one of the four buttons corresponding to the four phases is displayed in an operable manner in accordance with the progress of the security arrangement.

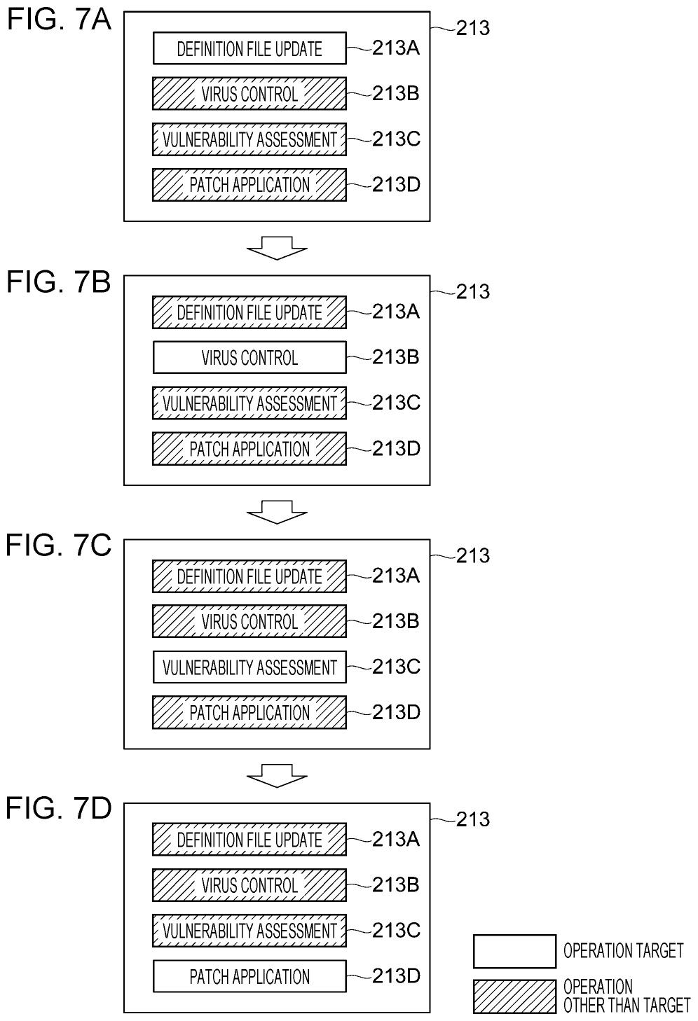

FIGS. 7A through 7D illustrate the transition of the screen used in a security arrangement. FIG. 7A illustrates an example of a screen immediately after the start of the security arrangement, FIG. 7B illustrates an example of a screen when the update of a definition file is complete, FIG. 7C illustrates a screen when a virus is controlled, and FIG. 7D illustrates a screen when vulnerability assessment ends.

Referring to FIGS. 7A through 7D, only the target buttons are displayed in higher brightness and the buttons other than the target buttons are displayed in lower brightness.

Referring to FIG. 7A, only the definition file update button 213A is displayed in higher brightness and the remaining three buttons are displayed in lower brightness. This arrangement reduces the risk that the operation order of the buttons is mistaken. The difference in brightness is to be visually differentiated. For example, the brightness of a button of an untargeted operation is set to be as low as or lower than the brightness of a button of a targeted operation.

The operability of a button may be represented by flashing the button, by the size difference of the button, or by the color difference of the button.

Only a button serving as an operation target may be flashed. The button may be flashed partially or wholly.

The button serving as an operation target may set to be larger in size than the button that is not an operation target. The size difference is to be visually differentiated. For example, a button serving as an operation target may be set to be twice as large in area as a button that is not an operation target.

The background of a button as an operation target may be set to be white or blue and the background of a button that is not an operation target may be set to be red or gray.

If the administrator operates a wrong button in lower brightness, the progress manager 221 invalidates the operation. If an invalid operation is received, the processor 211A may notify the administrator of an operation mistake. For example, a message reading “Designated phase is wrong,” “Please designate a correct phase,” or “Please operate the virus control button.”

While a designated phase is in progress, all the buttons may be displayed in lower brightness or an indication indicating that a specific phase is in progress may be displayed on the screen.

Returning to FIG. 6, if a screen ready to receive an instruction to execute a phase is displayed, the processor 211A determines whether a button of an operable phase is designated (step S3).

While the no path is followed in step S3, the processor 211A repeats the determination operation in step S3.

If the yes path is followed in step S3, the processor 211A instructs isolation to be performed using the white list of the corresponding phase (step S4).

In other words, the processor 211A permits the computer (FIG. 1) connected via the remote desktop to perform the communication of the program included in the white list of the corresponding phase.

For example, if an operation of the definition file update button 213A (FIG. 7A) is received, the processor 211A instructs the computer 31 to perform the definition file update phase.

In this case, the processor 211A designates the use of the white list corresponding to the definition file update phase.

According to the first exemplary embodiment, the processor 211A permits all the white lists for the definition file update to be used. For example, the utilization of the white list of McAfee Corp. and the white list of Microsoft Corporation may be permitted.

The virus control programs used by clients using the security arrangement service may be various and the utilization of white lists of multiple products is thus permitted.

When isolation starts using a program described in a white list, the processor 211A determines whether the last phase is complete (step S5).

The last phase is the patch application phase.

If the no path is followed in step S5, the processor 211A updates the operable phase (step S6) and returns to step S2. Specifically, while the no path is followed in step S5, the processor 211A returns to step S2 via step S6.

If the yes path is followed in step S5, the processor 211A ends the process for the security arrangement.

### Communication Sequence

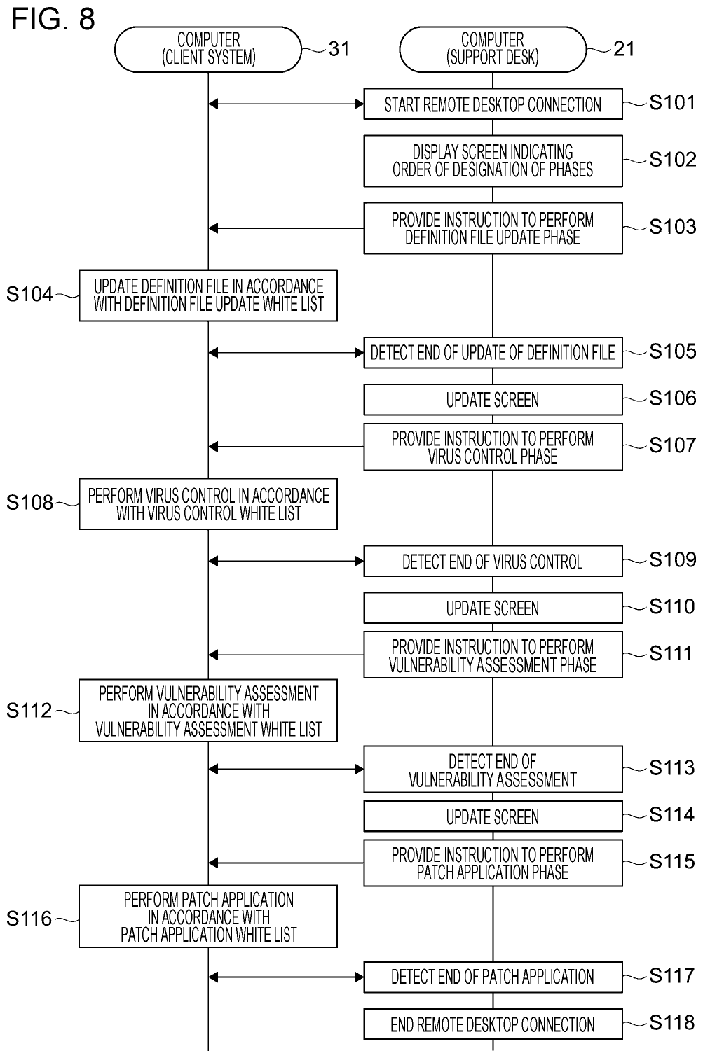

FIG. 8 illustrates an example of communication performed between the computer 21 on the support desk 20 (FIG. 1) and the computer 31 on the client system 30 (FIG. 1).

The computer 21 starts remote desktop connection with the computer 31 as a providing destination of the security arrangement (step S101).

The computer 21 displays a screen indicating the designation order of the phases (step S102). Specifically, the screen in FIG. 7A is displayed on the display 213 (FIG. 2) of the computer 21 operated by the administrator. The screen where only the definition file update button 213A (FIG. 7A) is operable is displayed.

When the administrator operates the definition file update button 213A, the computer 21 instructs the computer 31 connected via the remote desktop to perform the definition file update phase (step S103).

The computer 31 having received the instruction updates the definition file in accordance with the definition file update white list (step S104).

Specifically, the computer 31 permits only the communication supported by a program included in the white list to be performed and updates the definition file. In communication with the outside, only the communication supported by the program included in the white list is permitted.

A program vulnerably to viruses is not included in the white list. Even when the computer 31 is infected with a virus, communication maliciously used by the virus remains unexecuted.

When the computer 21 detects the end of the update of the definition file on the computer 31 serving as the providing destination of the security arrangement (step S105), the computer 21 updates the screen (step S106). Specifically, the display 213 is transitioned to the screen in FIG. 7B.

When the administrator operates the virus control button 213B, the computer 21 instructs the computer 31 connected via the remote desktop to perform the virus control phase (step S107).

The computer 31 having received the instruction performs virus control in accordance with the virus control white list (step S108). A virus corresponding to the latest definition file is removed at this stage. The execution of the phase may reduce the risk of the virus.

When the computer 21 detects the end of the virus control on the computer 31 serving as the providing destination of the security arrangement (step S109), the computer 21 updates the screen (step S110). Specifically, the display 213 transitions to the screen in FIG. 7C.

When the administrator operates the vulnerability assessment button 213C, the computer 21 instructs the computer 31 connected via the remote desktop to perform the vulnerability assessment phase (step S111).

The computer 31 having received the instruction performs the vulnerability assessment in accordance with the vulnerability assessment white list (step S112).

Vulnerability to viruses is thus assessed. Specifically, only the communication supported by the program included in the white list is permitted to assess vulnerability. The communication with the outside to be permitted is only the communication supported by the program included in the white list.

When the computer 21 detects the end of the vulnerability assessment on the computer 31 serving as the providing destination of the security arrangement (step S113), the computer 21 updates the screen (step S114). Specifically, the display 213 transitions to the screen in FIG. 7D.

When the administrator operates the patch application button 213D, the computer 21 instructs the computer 31 connected via the remote desktop to perform the patch application phase (step S115).

The computer 31 having received the instruction applies a patch in accordance with the patch application white list (step S116). A location vulnerable to the virus is corrected.

When the computer 21 detects the end of the patch application on the computer 31 serving as the providing destination of the security arrangement service (step S117), the computer 21 ends the remote desktop connection (step S118).

### Conclusion of First Exemplary Embodiment

According to the first exemplary embodiment, in the first phase for the security arrangement, the definition file is updated using the white list and in the second phase, the virus control is performed in accordance with the latest definition file. For this reason, the safety of the communication is assured in the subsequent phases, namely, during the vulnerability assessment and patch application.

According to the first exemplary embodiment, the security arrangement by the administrator is guided in the order of sequence of phases in accordance with which the safety of the communication is assured. The safety of the communication may thus increase while the phases are in progress.

The communication with the outside in each of the phases is limited to the communication that uses the dedicated white list. Free communication by the virus with the outside may thus be controlled.

### Second Exemplary Embodiment

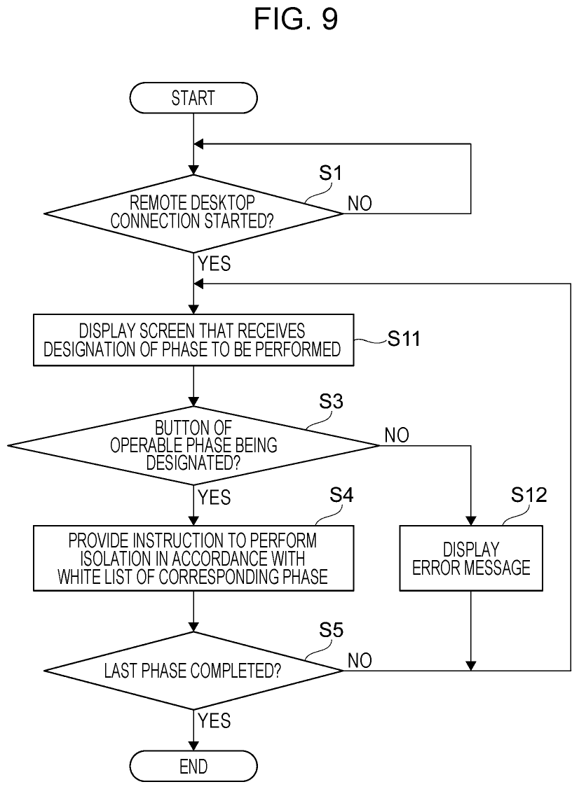

FIG. 9 is a flowchart illustrating the process of another program executed on the computer 21 (FIG. 1) operated by the administrator who provides the security arrangement service. Referring to FIG. 9, steps identical to the steps in FIG. 6 are designated with the same step numbers.

According to a second exemplary embodiment, the processor 211A determines whether the remote desktop connection with the computer 31 serving as the providing destination of the security arrangement service has started (step S1).

While the no path is followed in step S1, the processor 211A repeats the determination operation in step S1.

If the yes path is followed in step S1, the processor 211A displays on the display 213 (FIG. 2) the screen ready to receive the designation of the phase to be performed (step S11).

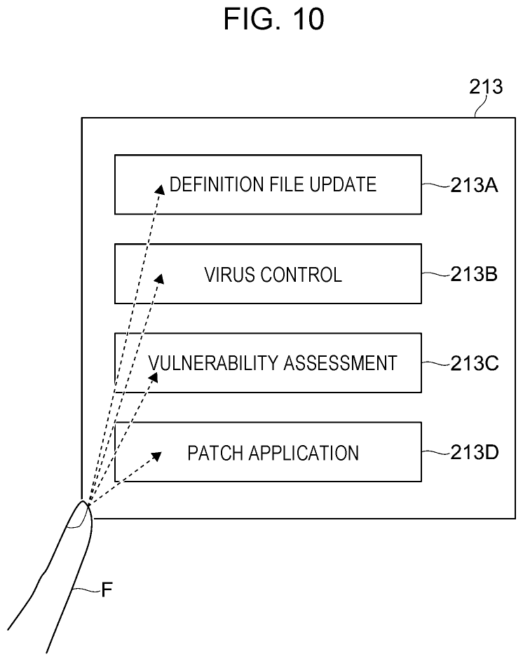

FIG. 10 illustrates a security arrangement screen used in the second exemplary embodiment. Referring to FIG. 10, elements identical to the elements in FIG. 5 are designated with the same symbol numbers.

According to the second exemplary embodiment, the display form of the buttons on the screen remains unchanged regardless of the phase progress.

Specifically, the definition file update button 213A, virus control button 213B, vulnerability assessment button 213C, and patch application button 213D are displayed in the same manner. Referring to FIG. 10, every button is displayed in higher brightness.

The administrator is thus unable to learn a button to be operated from the display form of the buttons. As a result, the administrator may tap a wrong button with the finger F or select a wrong button with a mouse cursor in the security arrangement.

Returning to FIG. 9, in response to the reception of an operation on a displayed button, the processor 211A determines whether a button of an operable phase has been designated (step S3).

If the no path is followed in step S3, the processor 211A display an error message (step S12) and returns to step S11.

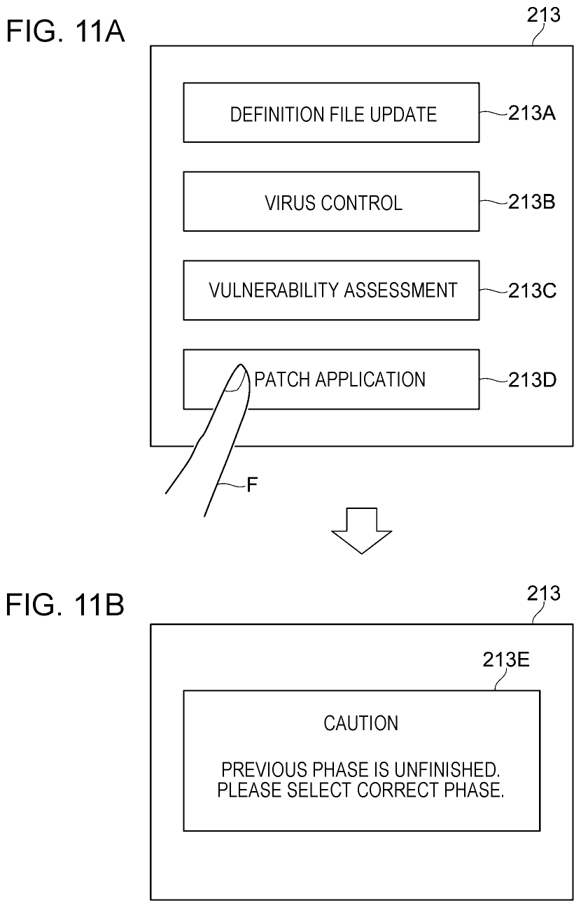

FIGS. 11A and 11B illustrate a display example of the error message displayed when the button of the wrong phase is operated. FIG. 11A illustrates an operation example of a button by the administrator. FIG. 11B illustrates a display example of an error message 213E.

Referring to FIGS. 11A and 11B, the administrator taps the patch application button 213D with the finger F. If a wrong button is operated, the processor 211A displays the error message 213E.

Referring to FIGS. 11A and 11B, the error message 213E includes character strings “Caution,” “Previous phase is unfinished.” and “Please select correct phase.”

The error message 213E in FIG. 11B disappears from the screen in a predetermined period of time and the display reverts to the screen in FIG. 11A. The error message 213E is repeatedly displayed until the administrator operates a correct button.

The error message 213E may include a back button and if the back button is operated, the display reverts to the screen in FIG. 11A.

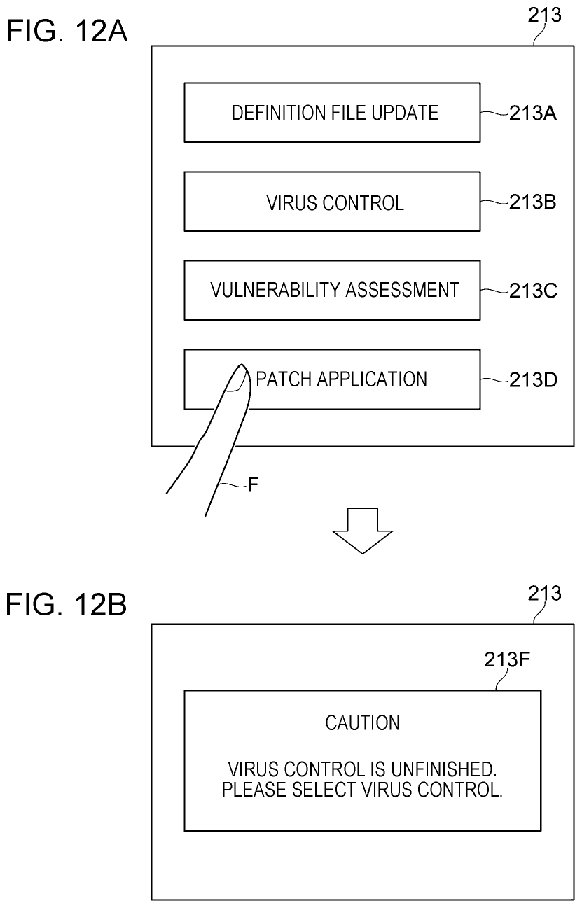

FIGS. 12A and 12B illustrate another display example of the error message displayed when the button of a wrong phase is operated. FIG. 12A illustrates an operation example of a button by the administrator. FIG. 12B illustrates a display example of an error message 213F.

Referring to FIGS. 12A and 12B, the error message 213F includes character strings “Caution,” “Virus control is unfinished.” and “Please select virus control.” The error message 213F suggests a button to be operated. The administrator may thus easily operate the correct button.

Returning to FIG. 9, if the yes path is followed in step S3, the processor 211A instructs isolation to be performed in accordance with the white list of the corresponding phase (step S4). Specifically, the processor 211A permits the communication of the program included in the white list of the corresponding phase to be performed via the communication with the computer 31 (FIG. 1) connected via the remote desktop.

When isolation using the program written in the white list starts, the processor 211A determines whether the last phase is complete (step S5).

If the no path is followed in step S5, the processor 211A returns to step S11.

On the other hand, if the yes path is followed in step S5, the processor 211A ends the process related to the security arrangement.

### Conclusion of Second Exemplary Embodiment

According to the second exemplary embodiment, if a wrong phase is selected on the screen operated by the administrator, the selection of the administrator is invalidated and the error message is displayed on the display 213.

The displaying of the error message guides the administrator to the security arrangement in the order of sequence of phases that assures the safety of the communication.

The second exemplary embodiment may provide the same technical effect as the first exemplary embodiment.

### Third Exemplary Embodiment

According to the first and second exemplary embodiments, the administrator on the support desk 20 (FIG. 1) provides an instruction to perform the phase to the computer 31 serving as the providing destination of the security arrangement. According to a third exemplary embodiment, only an instruction to start the security arrangement is provided.

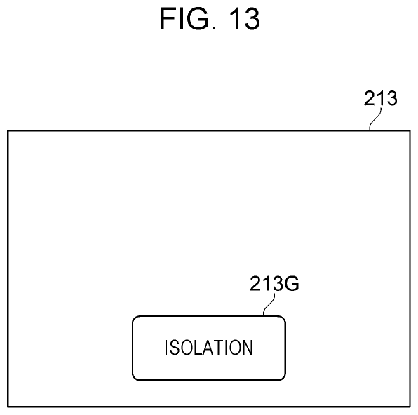

FIG. 13 illustrates a security arrangement screen used in the third exemplary embodiment.

The screen in FIG. 13 includes only an isolation button 213G but the screen in FIG. 13 may include further information. The button may be designated with a different name.

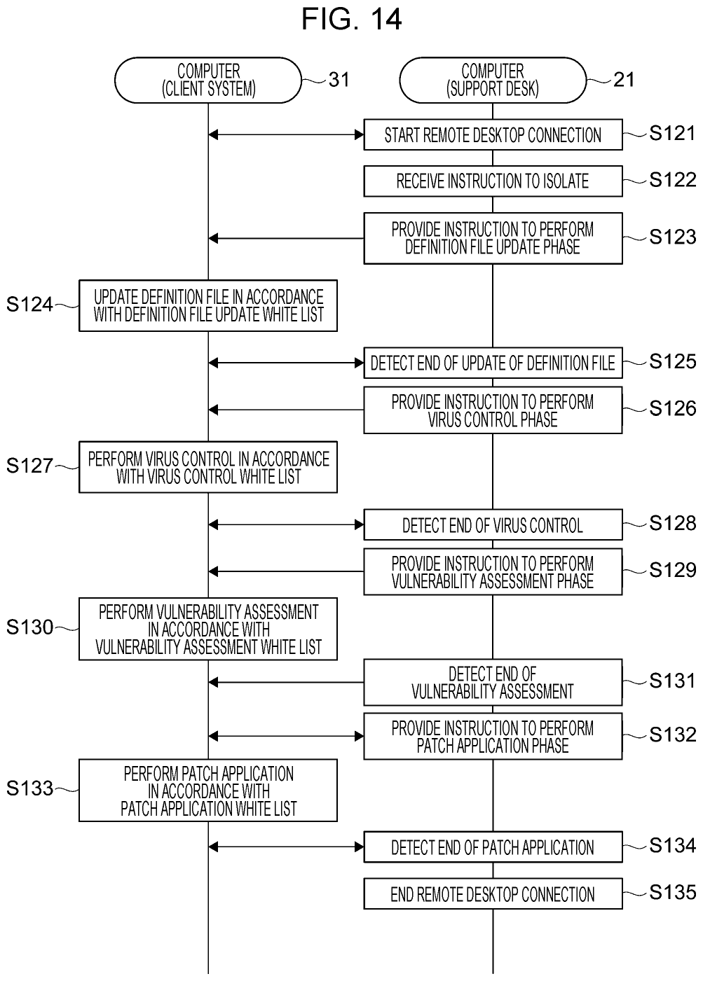

FIG. 14 illustrates an example of communication performed the computer 21 on the support desk 20 (FIG. 1) and the computer 31 on the client system 30 (FIG. 1).

The processor 211A starts the remote desktop connection with the computer 31 serving as the providing destination of the security arrangement (step S121).

The processor 211A receives via the display 213 (FIG. 13) an instruction to perform isolation (step S122).

The processor 211A instructs the computer 31 serving as the providing destination of the security arrangement to perform the definition file update phase (step S123).

The computer 31 having received the instruction updates the definition file in accordance with the definition file update white list (step S124).

If the computer 21 detects via an execution log the end of the update of the definition file on the computer 31 serving as the providing destination of the security arrangement (step S125), the computer 21 provides an instruction to perform the virus control phase (step S126).

The computer 31 having received the instruction performs the virus control in accordance with the virus control white list (step S127).

When the computer 21 detects via the execution log the end of the virus control on the computer 31 serving as the providing destination of the security arrangement (step S128), the computer 21 provides an instruction to perform the vulnerability assessment phase (step S129).

The computer 31 having received the instruction performs the vulnerability assessment in accordance with the vulnerability assessment white list (step S130).

When the computer 21 detects via the execution log the end of the vulnerability assessment on the computer 31 serving as the providing destination of the security arrangement (step S131), the computer 21 provides an instruction to perform the patch application phase (step S132).

The computer 31 having received the instruction performs the patch application in accordance with the patch application white list (step S133).

When the computer 21 detects via the execution log the end of the patch application on the computer 31 serving as the providing destination of the security arrangement (step S134), the computer 21 ends the remote desktop connection (step S135).

### Conclusion of Third Exemplary Embodiment

According to the third exemplary embodiment, if the administrator provides an instruction to start the security arrangement, a series of security arrangement steps are automatically instructed in a correct order of sequence to the computer 31 serving as the providing destination of the security arrangement. According to the third exemplary embodiment, all predetermined four phases are performed in a predetermined order even without the administrator designating the phases to be performed.

### Fourth Exemplary Embodiment

A fourth exemplary embodiment is described below. The fourth exemplary embodiment is a modification of the third exemplary embodiment. According to the third exemplary embodiment, if the administrator provides an instruction to start the security arrangement, all four phases are performed from the start in the order of sequence.

In the third exemplary embodiment, even the computer 31 having completed the virus control performs all four phases from the start in the order of sequence.

The fourth exemplary embodiment includes a mechanism to control the execution of the phases in response to whether the virus control is complete.

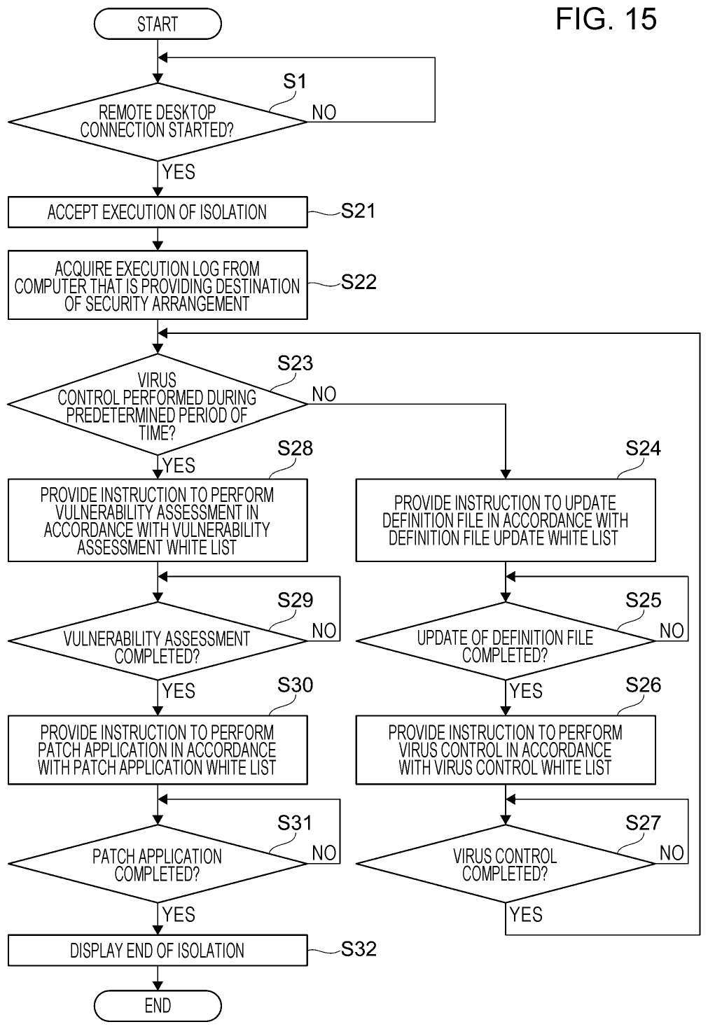

FIG. 15 is a flowchart illustrating the process of another program executed by the computer 21 (FIG. 1) operated by the administrator who provides the security arrangement service. In FIG. 15, steps identical to the steps in FIG. 6 are designated with the same step numbers.

The processor 211A determines whether the remote desktop connection with the computer 31 serving as a target has started (step S1).

While the no path is followed in step S1, the processor 211A repeats the determination operation in step S1.

If the yes path is followed in step S1, the processor 211A receives an instruction to perform isolation via the display 213 (FIG. 13) (step S21). Specifically, an operation of the perform isolation button 213G (FIG. 13) is received.

The processor 211A acquires an execution log from the computer 31 serving as the providing destination of the security arrangement (step S22).

The processor 211A determines whether the virus control has been completed within a predetermined period of time (step S23).

The following two states described below are verified herein.

A first state is whether the virus control has been performed and a second state is whether the virus control is to be performed within a predetermined period of time.

The second state is to be verified because the safety of the communication of the computer 31 becomes different depending on whether the virus control has been performed or not.

The first state is to be verified because if a long time has elapsed since the previous execution of the virus control, the possibility of being infectious with a new virus may increase.

According to the fourth exemplary embodiment, the start of the predetermined period of time may be start time of the present remote desktop connection. Alternatively, the start of the predetermined period of time may be time when the present security arrangement has been received. Alternatively, the start of the predetermined period of time may be one hour earlier than the start time of the present remote desktop connection.

If the no path is followed in step S23, the processor 211A provides an instruction to update the definition file in accordance with the definition file update white list 331 (FIG. 4) (step S24).

The processor 211A references the execution log to determine whether the definition file has been updated (step S25).

While the no path is followed in step S25, the processor 211A repeats the determination operation in step S25.

If the yes path is followed in step S25, the processor 211A provides an instruction to perform the virus control in accordance with the virus control white list (step S26).

The processor 211A references the execution log to determine whether the virus control has been completed (step S27).

While the no path is followed in step S27, the processor 211A repeats the determination operation in step S27.

If the yes path is followed in step S27, the processor 211A returns to step S23.

If the yes path is followed in step S23, the processor 211A provides an instruction to perform the vulnerability assessment in accordance with the vulnerability assessment white list (step S28).

The processor 211A references the execution log to determine whether the vulnerability assessment has been completed (step S29).

While the no path is followed in step S29, the processor 211A repeats the determination operation in step S29.

If the yes path is followed in step S29, the processor 211A provides an instruction to perform the patch application in accordance with the patch application white list (step S30).

The processor 211A references the execution log to determine whether the patch application has been completed (step S31).

While the no path is followed in step S31, the processor 211A repeats the determination operation in step S31.

If the yes path is followed in step S31, the processor 211A displays the end of the isolation (step S32).

### Conclusion of Fourth Exemplary Embodiment

According to the fourth exemplary embodiment, only the vulnerability assessment phase and patch application phase are performed on the computer 31 on which the virus control has been completed within the predetermined period of time.

The execution of the phase is not duplicated while the safety of the communication is assured. Working hours per apparatus for the security arrangement may thus be reduced.

### Fifth Exemplary Embodiment

A fifth exemplary embodiment is a combination of the first exemplary embodiment and fourth exemplary embodiment. Specifically, target phases to be designated by the administrator are sorted into two types, one before the virus control and the other after the virus control.

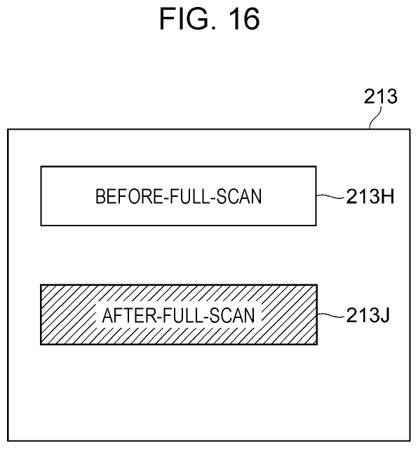

FIG. 16 illustrates an example of screen for the security arrangement employed in the fifth exemplary embodiment.

The screen in FIG. 16 is also displayed on the display 213 of the computer 21 (FIG. 1) operated by the administrator.

The screen in FIG. 16 includes two buttons. One is a “before-full-scan” button 213H and the other is an “after-full-scan” button 213J.

The full scan is also referred to as a complete scan and is used to check the entire system. An example of the full scan is performed to check a system memory, a program read at the startup time, a file restoring the system (hereinafter referred to as a system restore file), mails, hard disk drive, removable disk drive, and network drive.

Scans other than the full scan include a simple scan, object scan, and removable drive scan. The simple scan contrasts with the full scan that checks a program read at the operating system (OS) startup, system memory, and boot sector. In the object scan, the user designates an object as a scan target. In the removable drive scan, a removable disk drive is checked.

The fifth exemplary embodiment assumes the execution of the full scan but may utilize another type of scan. The full scan may be performed to remove a known virus.

The before-full-scan button 213H corresponds to the definition file update phase and virus control phase. The after-full-scan button 213J corresponds to the vulnerability assessment phase and patch application phase.

These two buttons are examples of an operator.

Referring to FIG. 16, the before-full-scan button 213H is displayed in higher brightness and the after-full-scan button 213J is displayed in lower brightness.

The screen in FIG. 16 indicates that the before-full-scan button 213H is an operation target and that the after-full-scan button 213J is not an operation target.

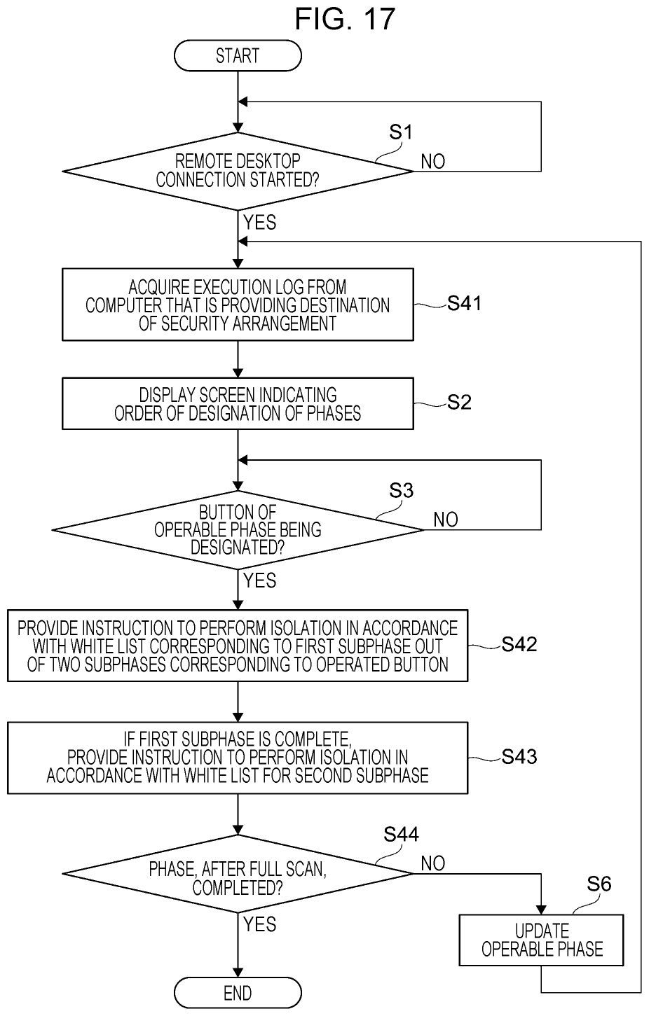

FIG. 17 is a flowchart illustrating the process of a program executed by the computer 21 (FIG. 1) operated by the administrator who provides the security arrangement service. In FIG. 17, steps identical to the steps in FIG. 6 are designated with the same step numbers.

The process in FIG. 17 is also performed by the processor 211A (FIG. 2) in the computer 21.

The processor 211A determines whether a remote desktop connection with the computer 31 serving as the providing destination of the security arrangement service has started (step S1).

While the no path is followed in step S1, the processor 211A repeats the determination operation in step S1.

If the yes path is followed in step S1, the processor 211A acquires the execution log from the computer 31 serving as the providing destination of the security arrangement (step S41). The execution log thus acquired indicates the progress of the security arrangement of the computer 31.

The processor 211A displays on the display 213 (FIG. 2) a screen indicating the order of designation of the phase (step S2).

The phase herein is managed according to whether the phase is before the full scan or after the full scan. Specifically, the screen in FIG. 16 is displayed.

The processor 211A determines whether a button with an operable phase is designated (step S3).

While the no path is followed in step S3, the processor 211A repeats the determination operation in step S3.

If the yes path is followed in step S3, the processor 211A provides an instruction to perform isolation in accordance with the white list corresponding to a first subphase of two subphases of the operated button (step S42). For example, the processor 211A provides an instruction to update the definition file.

According to the fifth exemplary embodiment, two phases corresponding to each button are referred to as subphases.

The subphases are in order relation. A subphase that is to be performed first is referred to as a first subphase and a subphase to be performed subsequently is referred to as a second subphase.

When the first subphase is complete, the processor 211A provides an instruction to perform isolation in accordance with the white list corresponding to the second subphase (step S43). For example, the processor 211A provides an instruction to perform the virus control.

When the second subphase is complete, the processor 211A determines whether the phase subsequent to the full scan is complete (step S44). In other words, the processor 211A determines whether the patch application phase is complete.

If the no path is followed in step S44, the processor 211A updates the operable phase (step S6) and returns to step S41. Specifically, the before-full-scan button 213H (FIG. 16) transitions to lower brightness and the after-full-scan button 213J (FIG. 16) transitions to higher brightness.

If the yes path is followed in step S44, the processor 211A ends the process related to the security arrangement.

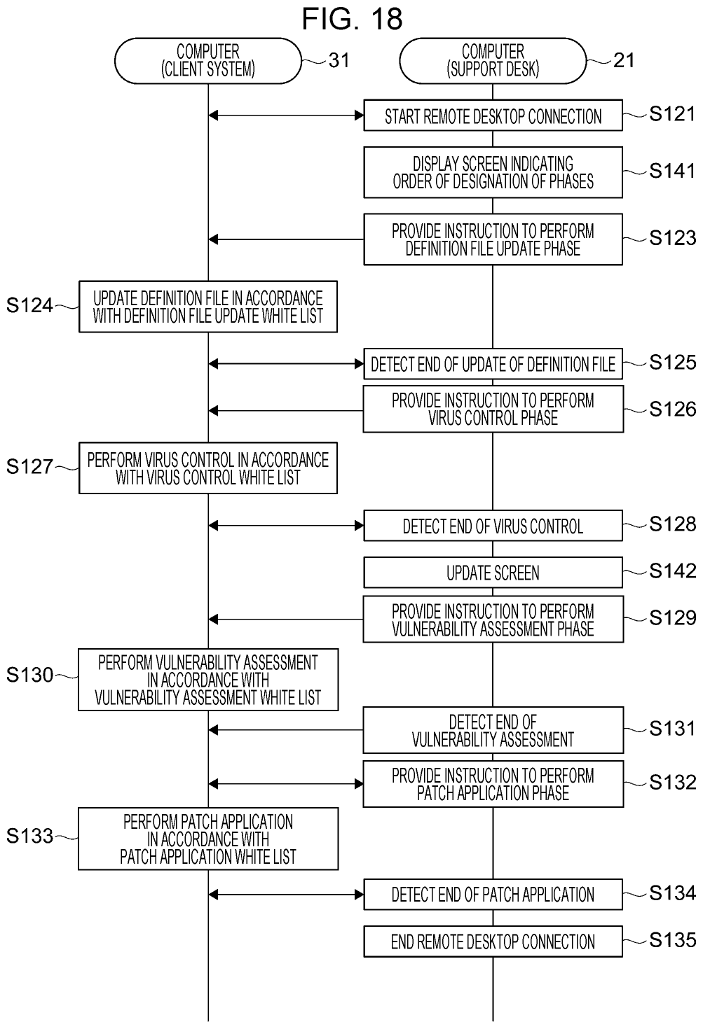

FIG. 18 illustrates an example of communication performed between the computer 21 on the support desk 20 (FIG. 1) and the computer 31 on the client system 30 (FIG. 1).

The processor 211A starts the remote desktop connection with the computer 31 serving as the providing destination of the security arrangement (step S121).

The processor 211A displays a screen indicating the order of designation of the phases (step S141). At this moment, only the before-full-scan button 213H is operable.

If the operation of the before-full-scan button 213H is detected, the processor 211A instructs the computer 31 as a target to perform the definition file update phase (step S123).

The computer 31 having received the instruction updates the definition file in accordance with the definition file update white list (step S124).

If the computer 21 detects via an execution log the end of the update of the definition file on the computer 31 serving as the providing destination of the security arrangement (step S125), the computer 21 provides an instruction to perform the virus control phase (step S126).

The computer 31 having received the instruction performs the virus control in accordance with the vulnerability assessment white list (step S127).

When the computer 21 detects via the execution log the end of the virus control on the computer 31 serving as the providing destination of the security arrangement (step S128), the computer 21 updates the screen of the display 213 (FIG. 16) operated by the administrator (step S142). Specifically, the computer 21 updates the display 213 in a manner that allows only the after-full-scan button 213J to be operable.

When the after-full-scan button 213J is operated, the processor 211A instructs the computer 31 serving as the providing destination of the security arrangement to perform the vulnerability assessment phase (step S129).

The computer 31 having received the instruction performs the vulnerability assessment in accordance with the vulnerability assessment white list (step S130).

When the computer 21 detects via the execution log the end of the vulnerability assessment on the computer 31 serving as the providing destination of the security arrangement (step S131), the computer 21 provides an instruction to perform the patch application phase (step S132).

The computer 31 having received the instruction performs the patch application in accordance with the patch application white list (step S133).

When the computer 21 detects via the execution log the end of the patch application on the computer 31 serving as the providing destination of the security arrangement (step S134), the computer 21 ends the remote desktop connection (step S135).

### Conclusion of Fifth Exemplary Embodiment

According to the fifth exemplary embodiment, the administrator is enabled to perform the security arrangement in the phases separately, the two phases before the full scan and the other two phases after the full scan.

The after-full-scan button 213J is operable only if the end of the virus control is confirmed in the execution log. For this reason, the communication with the outside for the vulnerability assessment and the patch application is not performed before the virus control. As the first exemplary embodiment, the fifth exemplary embodiment may also benefit a higher safety of the communication.

### Sixth Exemplary Embodiment

A sixth exemplary embodiment is a modification of the second exemplary embodiment.

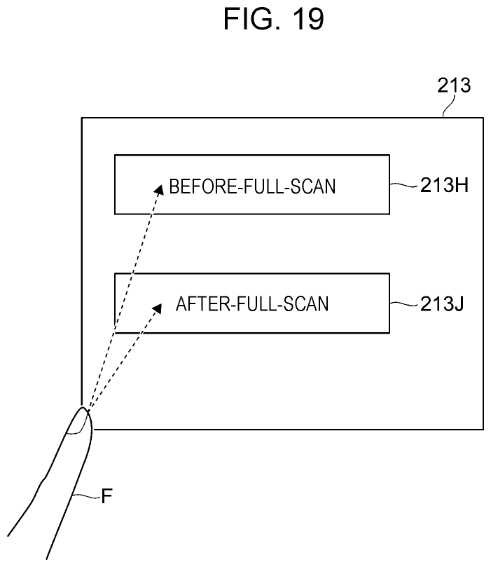

FIG. 19 illustrates an example of a security arrangement screen used in the sixth exemplary embodiment. The display forms of the before-full-scan button 213H and after-full-scan button 213J remain unchanged regardless of the progress of the phases.

According to the sixth exemplary embodiment, the administrator is unable to know a button to be operated from the display form of the button. As a result, the administrator may possibly tap a wrong button with the finger F or select a wrong button with a mouse cursor.

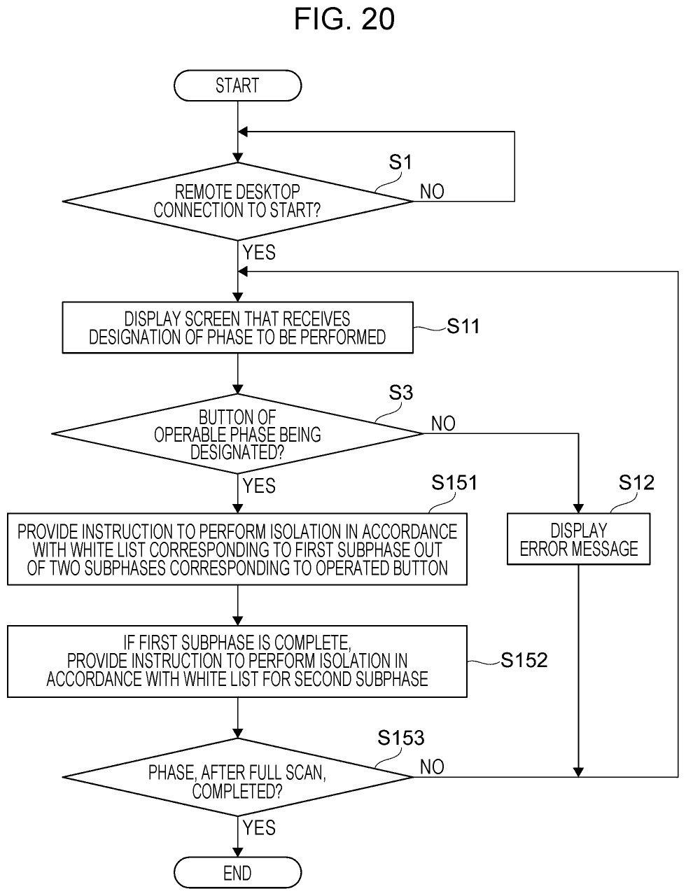

FIG. 20 is a flowchart illustrating the process of another program executed by the computer 21 (FIG. 1) operated by the administrator who provides the security arrangement service. In FIG. 20, steps identical to the steps in FIG. 9 are designated with same step numbers.

According to the sixth exemplary embodiment, the processor 211A determines whether a remote desktop connection with the computer 31 serving as the providing destination of the security arrangement service has started (step S1).

While the no path is followed in step S1, the processor 211A repeats the determination operation in step S1.

If the yes path is followed in step S1, the processor 211A displays on the display 213 (FIG. 2) a screen indicating the designation of a phase to be performed (step S11). Specifically, the screen in FIG. 19 is displayed.

In response to the reception of an operation on the displayed button, the processor 211A determines whether a button with an operable phase has been designated (step S3).

When the no path is followed in step S3, the processor 211A displays an error message (step S12) and returns to step S11.

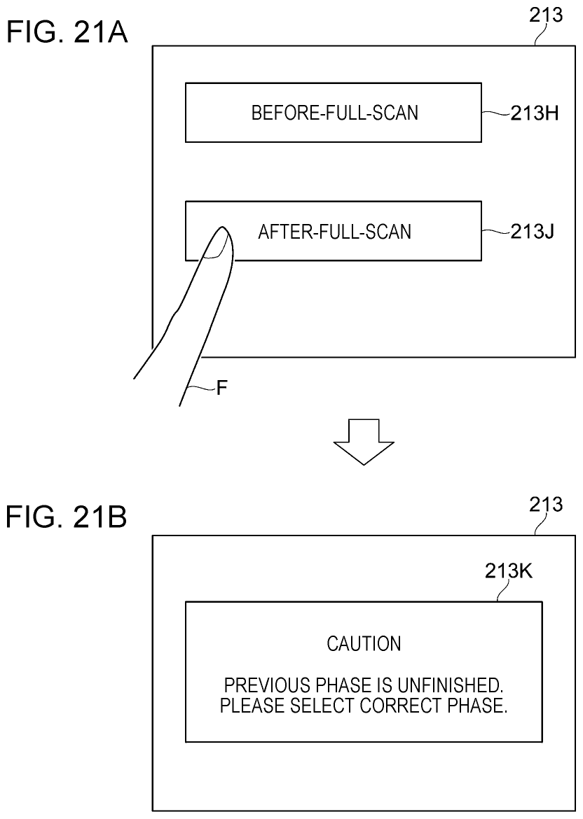

FIGS. 21A and 21B illustrate a display example of an error message displayed when a wrong phase button is operated. FIG. 21A illustrates an operation example of a button operated by the administrator and FIG. 21B illustrates a display example of an error message 213K.

Referring to FIGS. 21A and 21B, the administrator taps the after-full-scan button 213J. If a wrong button is tapped, the processor 211A displays the error message 213K.

Referring to FIG. 21B, the error message 213K includes character strings “Caution,” “Previous phase is unfinished.” and “Please select correct phase.”

The error message 213K in FIG. 21B disappears in a predetermined period of time and the display 213 reverts back to the screen in FIG. 21A.

The error message 213K may include a back button. If the back button is operated, the display 213 reverts back to the screen in FIG. 21A.

Returning to FIG. 20, if the yes path is followed in step S3, the processor 211A provides an instruction to perform isolation in accordance with the white list corresponding to a first subphase of two subphases of the operated button (step S151). The operation in step S151 is identical to the operation in step S42 (FIG. 17).

When the first subphase is complete, the processor 211A provides an instruction to perform isolation in accordance with the white list corresponding to the second subphase (step S152). The operation in step S152 is identical the operation in step S43 (FIG. 17).

When the second subphase is complete, the processor 211A determines whether the phase subsequent to the full scan is complete (step S153). In other words, the processor 211A determines whether the patch application phase is complete.

If the no path is followed in step S153, the processor 211A returns to step S11.

On the other hand, if the yes path is followed in step S153, the processor 211A ends the process of the security arrangement.

### Conclusion of Sixth Exemplary Embodiment

According to the sixth exemplary embodiment, if the administrator selects a wrong phase on the screen operated by the administrator, the selection is invalidated and the error message is displayed on the display 213.

In accordance with the error message, instructions for the security arrangement provided by the administrator are executed in the order of sequence of phases that assures the safety of communication.

The sixth exemplary embodiment may thus provide the same technical effect as the first exemplary embodiment.

### Seventh Exemplary Embodiment

A seventh exemplary embodiment provides multiple white lists different in strength to a single phase.

A higher strength of a white list signifies a lower possibility that an application with communication vulnerable to a virus is included in the white list. In other words, a white list having a higher strength is safer.

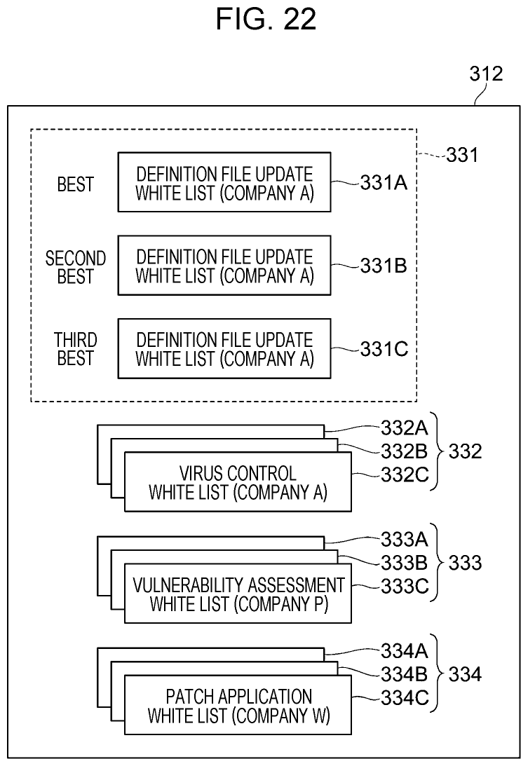

FIG. 22 illustrates a white list stored on the hard disk device 312.

In FIG. 22, elements identical to the elements in FIG. 4 are designated with the same reference numerals.

Referring to FIG. 22, the definition file update white lists 331 include three definition file update white lists 331A, 331B, and 331C different from each other in strength.

The definition file update white list 331A has the highest strength among the three white lists. In other words, the definition file update white list 331A includes no or few programs vulnerable to abuse. In FIG. 22, the definition file update white list 331A is labeled “Best.”

The definition file update white list 331B has the second highest strength among the three white lists. In other words, the definition file update white list 331B has the number of programs permitted to run larger than the best white list. If the number of programs permitted to run increases, the possibility that a program vulnerable to abuse is included increases. In FIG. 22, the definition file update white list 331B is labeled “Second best.”

The definition file update white list 331C has the lowest strength among the three white lists. In other words, the definition file update white list 331C has the number of programs permitted to run larger than the second best white list. In FIG. 22, the definition file update white list 331C is thus labeled “Third best.”

The number of white lists prepared for the definition file update are not limited to three. For example, the number of white lists prepared for the definition file update may be two or four or more.

Referring to FIG. 22, the hard disk device 312 stores the virus control white lists 332 including the best virus control white list 332A, the second best virus control white list 332B, and the third best virus control white list 332C.

The hard disk device 312 stores the vulnerability assessment white lists 333 including the best vulnerability assessment white list 333A, the second best vulnerability assessment white list 333B, and the third best vulnerability assessment white list 333C.

The hard disk device 312 stores the patch application white lists 334 including the best patch application white list 334A, the second best patch application white list 334B, and the third best patch application white list 334C.

Referring to FIG. 22, each of the four phases includes the same number of white lists. The number of white lists may be different from phase to phase.

For example, three white lists may be used for the definition file update phase, two white lists may be used for the virus control phase, four white lists may be used for the vulnerability assessment phase, and five white lists may be used for the patch application phase.

Multiple white lists may not necessarily be used for each of the four phases. For example, a single white list may be used for one of the four phases.

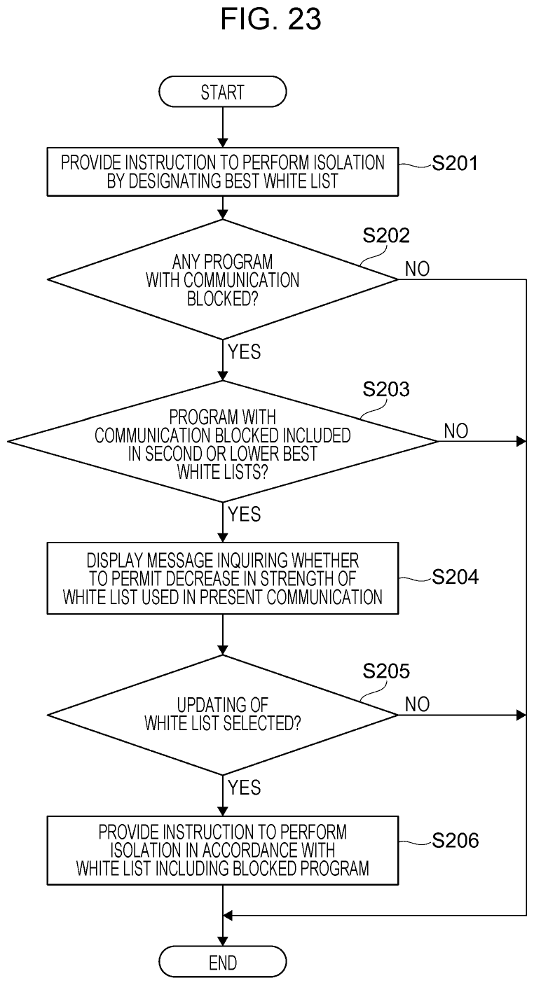

FIG. 23 illustrates an example of a process performed in a phase in which multiple white lists are available.

The process in FIG. 23 is performed by the computer 21 on the support desk 20 (FIG. 1). Specifically, the process in FIG. 23 is performed by the processor 211A.

The processor 211A provides an instruction to perform isolation by designating the best white list (step S201).

The processor 211A determines in accordance with the execution log whether there is a program with the communication thereof blocked (step S202).

If there is no program with the communication thereof block in the best white list, the processor 211A takes no path in step S202. In such a case, the definition file is updated via the communication with the outside.

If the no path is followed in step S202, the processor 211A shifts via the execution log to a step where the end of the corresponding phase is detected.

If the yes path is followed in step S202, the processor 211A determines whether a program with the communication thereof blocked is in the second or lower white list (step S203).

If an application with the communication thereof blocked in the best white list is included neither in the second best white list nor in the third best white list, the processor 211A proceeds along the no path in step S203.

In such a case, if the strength of the white list is increased, the communication with the outside is unsuccessful. If the no path is followed in step S203, the processor 211A shifts via the execution log to the step where the end of the corresponding phase is detected.

If the yes path is followed in step S203, the processor 211A displays a message inquiring whether to permit a decrease in the strength of the white list used for the present communication (step S204). According to the seventh exemplary embodiment, the message is displayed on the display 213 (FIG. 2) of the computer 21 (FIG. 1) operated by the administrator.

The display 213 displays a button used to provide an instruction to permit a change of the white list.

The processor 211A determines whether the update of the white list is selected (step S205).

If the no path is followed in step S205, the processor 211A shifts via the execution log to the step where the end of the corresponding phase is detected. In this case, the white list remains unchanged from the best.

If the yes path is followed in step S205, the processor 211A provides an instruction to perform isolation in accordance with the white list including the program blocked (step S206).

### Conclusion of Seventh Exemplary Embodiment

According to the seventh exemplary embodiment, the white list being safer is used with a higher priority. The change of the white list may be selected with the administrator's consent.

If the white list to be used in each phase is changed to another white list, the other white list is lower in strength than the best white list. A program permitted to run is limited to the program described in the white list. In comparison with the case in which any program is permitted to run, the safety of the communication may be still higher.

### Eighth Exemplary Embodiment

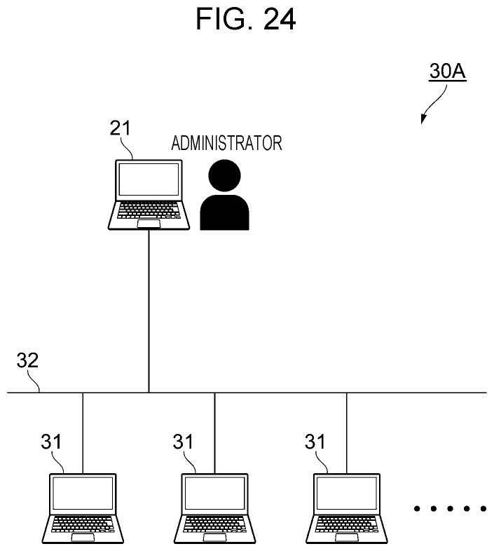

FIG. 24 illustrates a configuration example of a LAN system 30A according to an eight exemplary embodiment. In FIG. 24, elements identical to the elements in FIG. 1 are designated with the same reference numerals.

The LAN system 30A in FIG. 24 includes the computer 21 operated by the administrator and the computers 31 serving as targets of security service on the same network 32.

### Other Exemplary Embodiments

(1) Exemplary embodiments of the disclosure have been described. The technical scope of the disclosure is not limited to the scope described with reference to the exemplary embodiments. A variety of changes and modifications of the exemplary embodiments falls within the technical scope of the disclosure as defined by the appended claims.

(2) According the exemplary embodiments, the function of the computer 21 (FIG. 1) operated by the administrator in charge of the security arrangement is implemented by the phase monitor 322 (FIG. 3) managing the progress of the phases for the security arrangement. The same function may be implemented by executing a program installed on the computer 31 that is the providing destination of the security arrangement.

In such a case, the administrator may manage via the remote desktop the progress of a phase on the security arrangement on the computer 31.

The administrator or user may perform the security arrangement by directly operating the computer 31. Specifically, the administrator or user may manage the process of the phase on the security arrangement using the screen displayed on the display 313 (FIG. 3) in the computer 31 that is a target of the security arrangement.

In such a case, the computer 31 is an example of an information processing apparatus.

(3) According to the exemplary embodiments, the white list corresponding to each phase is stored on the computer (FIG. 1) serving as the process target. Each time an instruction to perform a phase is provided, the computer 21 (FIG. 1) operated by the administrator may provide the latest white list.

(4) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A non-transitory computer readable medium storing a program causing a computer to execute a process, the process comprising:
executing an application program corresponding to a sequence of a first phase updating a definition file of a virus, a second phase diagnosing with the definition file used and controlling the virus, a third phase assessing vulnerability, and a fourth phase applying a correction program.

2. The non-transitory computer readable medium according to claim 1, wherein the process comprises providing an instruction to reference white lists that are respectively prepared for the first phase, the second phase, the third phase, and the fourth phase.

3. The non-transitory computer readable medium according to claim 2, wherein the process comprises, if a plurality of white lists different in strength are available for one of the phases, referencing a white list having a higher strength with a higher priority.

4. The non-transitory computer readable medium according to claim 3, wherein the process comprises, if the application program with communication blocked by a white list being referenced is included in a white list as high in strength as a second best or lower than the second best, verifying a change in the white list to be referenced.

5. The non-transitory computer readable medium according to claim 1, wherein the process further comprises:
displaying on an operation screen four operators respectively corresponding to the first phase, the second phase, the third phase, and the fourth phase; and
receiving operations of the operators in an order of sequence.

6. The non-transitory computer readable medium according to claim 5, wherein receiving the operations of the operators comprises displaying one operator in a manner that permits the one operator to be operable in the order of sequence.

7. The non-transitory computer readable medium according to claim 5, wherein receiving the operations of the operators comprises, if an operation of an operator not agreeing with the order of sequence is received, invalidating the received operation of the operator and notifying a worker of an operation mistake.

8. The non-transitory computer readable medium according to claim 1, wherein the process comprises:
displaying on an operation screen an operator corresponding to the first phase and the second phase and an operator corresponding to the third phase and the fourth phase; and
receiving operations of the operators in an order of sequence.

9. The non-transitory computer readable medium according to claim 8, wherein receiving the operations of the operators comprises displaying one operator in a manner that permits the one operator to be operable in the order of sequence.

10. The non-transitory computer readable medium according to claim 8, wherein receiving the operations of the operators comprises, if an operation of an operator not agreeing with the order of sequence is received, invalidating the received operation of the operator and notifying a worker of an operation mistake.

11. A non-transitory computer readable medium storing a program causing a computer to execute a process, the process comprising:
verifying execution of scan in accordance with a definition file of a virus; and
if the execution of the scan is verified, permitting assessment of vulnerability and application of a correction program to be performed in an order of sequence.

12. The non-transitory computer readable medium according to claim 11, wherein the process comprises providing an instruction to reference a white list before and a white list after verification of the execution of the scan with the white list before the verification of the execution of the scan being different from the white list after the verification of the execution of the scan.

13. The non-transitory computer readable medium according to claim 12, wherein the process comprises, if a plurality of white lists different in strength are used before and/or after the verification of the execution of the scan, using a white list being higher in strength with a higher priority.

14. The non-transitory computer readable medium according to claim 13, wherein the process further comprises, if an application program with communication blocked by a white list being referenced is included in a white list as high in strength as a second best or lower than the second best, checking with a worker about a change in the white list to be referenced.

15. The non-transitory computer readable medium according to claim 11, wherein the scan is a full scan.

16. The non-transitory computer readable medium according to claim 12, wherein the scan is a full scan.

17. The non-transitory computer readable medium according to claim 13, wherein the scan is a full scan.

18. The non-transitory computer readable medium according to claim 14, wherein the scan is a full scan.

19. An information processing apparatus comprising:
a processor configured to:
cause to be performed an application program corresponding to a sequence of a first phase updating a definition file of a virus, a second phase diagnosing with the definition file used and controlling the virus, a third phase assessing vulnerability, and a fourth phase applying a correction program.

20. An information processing apparatus comprising:
a processor configured to:
verify execution of scan in accordance with a definition file of a virus; and
if the execution of the scan is verified, permit assessment of vulnerability and application of a correction program to be performed in an order of sequence.
